(19) United States
(12) Patent Application Publication
(10) Pub. No.: US 2025/0291119 A1
(43) Pub. Date: Sep. 18, 2025

(54) OPTICAL WAVEGUIDE STRUCTURE, OPTICAL WAVEGUIDE MODULE AND HEAD-MOUNTED DISPLAY DEVICE

(71) Applicants: Beijing Zitiao Network Technology Co., Ltd., Beijing (CN); Lemon Inc., Grand Cayman (KY)

(72) Inventors: Wen XIONG, Beijing (CN); Peng ZHANG, Los Angeles, CA (US)

(21) Appl. No.: 19/055,442

(22) Filed: Feb. 17, 2025

(30) Foreign Application Priority Data
Mar. 14, 2024 (CN) 202410296273.9

(51) Int. Cl. G02B 6/34; G02B 5/18; G02B 27/00; G02B 27/01

(52) U.S. Cl. CPC G02B 6/34; G02B 5/1842; G02B 5/1866; G02B 27/0081; G02B 27/0172; G02B 2027/0178

(57) ABSTRACT

The application discloses an optical waveguide structure, an optical waveguide module and a head-mounted display device. The optical waveguide structure according to an implementation of the disclosure includes a waveguide substrate, an in-coupling grating and an out-coupling grating. The in-coupling grating is used to couple input light into the waveguide substrate for transmission. The out-coupling grating is used to perform pupil expansion and out-coupling on light transmitted in the waveguide substrate. The out-coupling grating is a two-dimensional grating, and the two-dimensional grating has a two-dimensional structural element(s). A characteristic axis direction of the two-dimensional structural element(s) forms a relative rotation angle with a direction of a lattice period vector sum of the two-dimensional grating to change a diffraction efficiency of the out-coupling grating in a predetermined direction.

### CROSS-REFERENCE

This present application claims priority to Chinese Patent Application No. 2024102962739, entitled “OPTICAL WAVEGUIDE STRUCTURE, OPTICAL WAVEGUIDE MODULE AND HEAD-MOUNTED DISPLAY DEVICE” filed on Mar. 14, 2024, the entirety of which is incorporated herein by reference.

### FIELD

This application relates to the technical field of optical waveguides, and in particular, to an optical waveguide structure, an optical waveguide module, and a head-mounted display device.

### BACKGROUND

Optical waveguides are important components of augmented reality (AR) display devices. The basic principle is that the light emitted by optical mechanisms is coupled into the optical waveguides, and when the light propagates in the waveguides, it is guaranteed that the optical energy is not lost through total reflection until the light is coupled out at the position of a human eye. How to optimize the morphology of the grating by designing, thereby improving the efficiency of the optical waveguides is an important issue in the design of the optical waveguides.

### SUMMARY

Implementations of the present application provide an optical waveguide structure, an optical waveguide module, and a head-mounted display device, to solve at least one of the above technical problems.

An optical waveguide structure according to an implementation of the present disclosure includes:
a waveguide substrate;
an in-coupling grating configured to couple input light into the waveguide substrate for transmission;
an out-coupling grating configured to perform pupil expansion and out-coupling on light transmitted in the waveguide substrate, where the out-coupling grating is a two-dimensional grating, the two-dimensional grating has a two-dimensional structural element(s), and a characteristic axis direction of the two-dimensional structural element(s) forms a relative rotation angle with a direction of a lattice period vector sum of the two-dimensional grating to change a diffraction efficiency of the out-coupling grating in a predetermined direction.

In some implementations, the two-dimensional grating has a first lattice period direction and a second lattice period direction, a number of the two-dimensional structural element(s) is multiple, and the multiple two-dimensional structural elements are arranged in the first lattice period direction and the second lattice period direction;
the direction of the lattice period vector sum of the two-dimensional grating is a direction of a sum of a vector of the first lattice period direction and a vector of the second lattice period direction.

In some implementations, the two-dimensional structural element(s) has a first reciprocal lattice vector direction corresponding to the second lattice period direction and a second reciprocal lattice vector direction corresponding to the first lattice period direction, and the characteristic axis direction of the two-dimensional structural element(s) forms the relative rotation angle with the direction of the lattice period vector sum of the two-dimensional grating to change a diffraction efficiency of the out-coupling grating in the first reciprocal lattice vector direction or the second reciprocal lattice vector direction.

In some implementations, the first reciprocal lattice vector direction is perpendicular to the second lattice period direction, and the second reciprocal lattice vector direction is perpendicular to the first lattice period direction.

In some implementations, a magnitude of the relative rotation angle is determined based on a first lattice period length, a second lattice period length, and an angle between the first lattice period direction and the second lattice period direction.

In some implementations, the two-dimensional structural element(s) rotates in a first rotation direction, to enable the characteristic axis direction of the two-dimensional structural element(s) to form a negative relative rotation angle with the direction of the lattice period vector sum of the two-dimensional grating, thereby increasing a diffraction efficiency of the out-coupling grating in the first reciprocal lattice vector direction; where the first rotation direction is a rotation direction from the first lattice period direction to the second lattice period direction.

In some implementations, the out-coupling grating includes a first grating region corresponding to the first reciprocal lattice vector direction, and in the first grating region, the characteristic axis direction of the two-dimensional structural element(s) forms the negative relative rotation angle with the direction of the lattice period vector sum of the two-dimensional grating.

In some implementations, the two-dimensional structural element(s) rotates in a second rotation direction, to enable the characteristic axis direction of the two-dimensional structural element(s) to form a positive relative rotation angle with the direction of the lattice period vector sum of the two-dimensional grating, thereby increasing a diffraction efficiency of the out-coupling grating in the second reciprocal lattice vector direction; where the second rotation direction is a rotation direction from the second lattice period direction to the first lattice period direction.

In some implementations, the out-coupling grating includes a second grating region corresponding to the second reciprocal lattice vector direction, and in the second grating region, the characteristic axis direction of the two-dimensional structural element(s) forms the positive relative rotation angle with the direction of the lattice period vector sum of the two-dimensional grating.

In some implementations, in a direction away from the in-coupling grating, the relative rotation angle changes gradually or stepwise within a spatial range of the out-coupling grating.

An optical waveguide module according to an implementation of the present disclosure includes:
the optical waveguide structure of any of the above-mentioned implementations; and
an optical mechanism configured to emit the input light to the in-coupling grating.
The head-mounted display device according to an implementation of the present disclosure includes the optical waveguide module according to the above-mentioned implementations.

In the optical waveguide structure, the optical waveguide module and the head-mounted display device of the implementation of the present application, the characteristic axis direction of the two-dimensional structural element(s) forms a relative rotation angle with a direction of a lattice period vector sum of the two-dimensional grating to change a diffraction efficiency of the out-coupling grating in a predetermined direction.

Additional aspects and advantages of the present application will be given in part in the following description, parts of which will become apparent from the following description, or by the practice of the present application.

### BRIEF DESCRIPTION OF DRAWINGS

In order to more clearly illustrate the implementations of the present application or the technical solutions in the prior art, the accompanying drawings, which need to be used in the implementations or the description of the prior art, are briefly introduced below, and it will be apparent that the drawings in the following description are merely some implementations of the present application, and those skilled in the art may also obtain other drawings according to the structures shown in these drawings without creative efforts. wherein:

FIG. 1 is a schematic diagram of an optical waveguide structure according to some implementations of the present disclosure;

FIG. 2 is a schematic structural diagram of forming a relative rotation angle between a two-dimensional structural element and a two-dimensional grating according to some implementations of this application;

FIG. 3 is a schematic structural diagram of forming a relative rotation angle between a two-dimensional structural element and a two-dimensional grating according to some implementations of this application;

FIG. 4 is a schematic diagram of a calculation principle of a relative rotation angle according to some implementations of this application;

FIG. 5 is a schematic structural diagram of no relative rotation angle between a two-dimensional structural element and a two-dimensional grating;

FIG. 6 is a schematic diagram of diffraction efficiency of an out-coupling grating in a first backspace direction according to some implementations of the present disclosure;

FIG. 7 is a schematic diagram of diffraction efficiency of an out-coupling grating in a second backspace direction according to some implementations of the present disclosure;

FIG. 8 is a schematic diagram of an optical waveguide structure according to some implementations of the present disclosure;

FIG. 9 is a schematic diagram of an optical waveguide structure according to some implementations of the present disclosure;

FIG. 10 is a schematic diagram of an optical waveguide structure according to some implementations of the present disclosure;

FIG. 11 is a schematic diagram of an optical waveguide structure according to some implementations of the present disclosure;

FIG. 12 is a schematic diagram of spatial distribution of emergent light energy in an Eyebox region when there is no relative rotation angle between a two-dimensional structural element and a two-dimensional grating;

FIG. 13 is a schematic diagram of spatial distribution of emergent light energy in an EyeBox region when a two-dimensional structural element and a two-dimensional grating form a relative rotation angle according to some implementations of the present disclosure;

FIG. 14 is a schematic structural diagram of an optical waveguide module according to some implementations of this application;

FIG. 15 is a schematic structural diagram of a head-mounted display device according to some implementations of this application.

### DESCRIPTION OF REFERENCE NUMERALS

optical waveguide structure 100, waveguide substrate 10, in-coupling grating 20, out-coupling grating 30, two-dimensional grating 31, two-dimensional structural element 32, first grating region 33, second grating region 34, third grating region 35, optical mechanism 200, optical waveguide module 300, and head-mounted display device 100.

### DETAILED DESCRIPTION

Examples of implementations of the present application are described in detail below, examples of which are shown in the accompanying drawings, in which like or similar reference numerals refer to the same or similar elements throughout or elements having the same or similar functions. The implementations described below with reference to the accompanying drawings are exemplary, and are merely used to explain the present disclosure and cannot be construed as a limitation on the present disclosure.

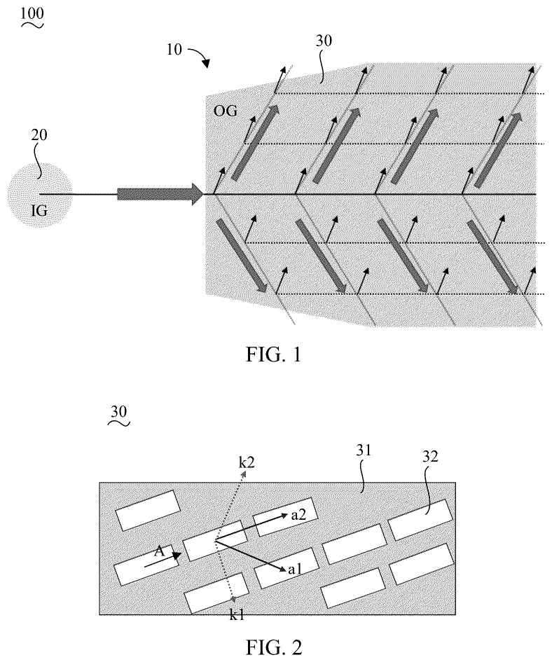

Referring to FIG. 1 and FIG. 2, an implementation of the present disclosure provides an optical waveguide structure 100. The optical waveguide structure 100 includes a waveguide substrate 10, an in-coupling grating 20, and an out-coupling grating 30. The in-coupling grating 20 is configured to couple the input light into the waveguide substrate 10 for transmission. The out-coupling grating 30 is configured to perform pupil expansion and out-coupling on light transmitted in the waveguide substrate 10. The out-coupling grating 30 is a two-dimensional grating 31 having a two-dimensional structural element(s) 32 therein. The characteristic axis direction of the two-dimensional structural element(s) 32 forms a relative rotation angle with a direction of a lattice period vector sum of the two-dimensional grating 31 to change a diffraction efficiency of the out-coupling grating 30 in a predetermined direction.

In the optical waveguide structure 100 of the implementation of the present disclosure, the characteristic axis direction of the two-dimensional structural element(s) 32 forms a relative rotation angle with a direction of a lattice period vector sum of the two-dimensional grating 31 to change a diffraction efficiency of the out-coupling grating 30 in a predetermined direction. Therefore, the morphology of the grating may be optimized, so as to improve the efficiency of the optical waveguide.

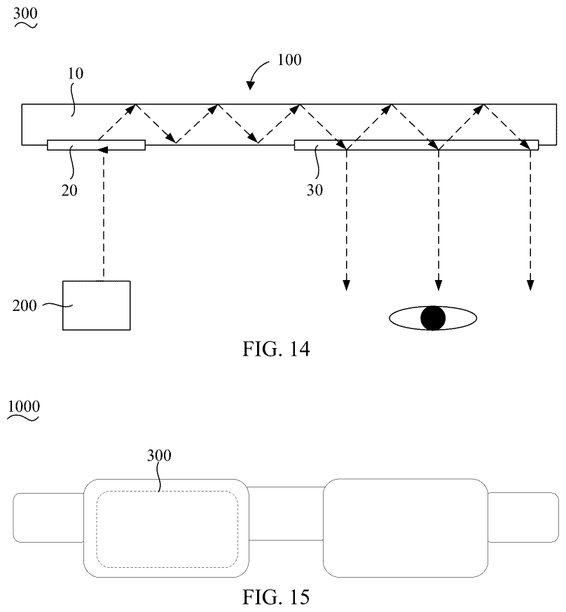

Referring to FIG. 14, in an implementation of the present disclosure, the light transmission process may be as follows: the optical mechanism 200 emits an input light toward the in-coupling grating 20, for example, the optical mechanism 200 emits the input light toward the in-coupling grating 20 in a direction perpendicular to an inward direction of the paper in FIG. 1; the input light is coupled into the waveguide substrate 10 through the in-coupling grating 20 for transmission, where the transmission of the light in the waveguide substrate 10 includes total reflection; and pupil expansion and out-coupling are performed on the light transmitted in the waveguide substrate 10 through the out-coupling grating 30, for example, a one-dimensional pupil expansion and/or a two-dimensional pupil expansion is performed on the light transmitted in the waveguide substrate 10 through the out-coupling grating 30, and the light transmitted in the waveguide substrate 10 is coupled out by the out-coupling grating 30 in a direction perpendicular to an outward direction of the paper in FIG. 1, so as to be received by the human eye.

Referring to FIG. 1 and FIG. 2, in a specific example of the present disclosure, the in-coupling grating 20 is represented by IG, and the out-coupling grating 30 is represented by OG. The in-coupling grating IG is used to provide an in-coupling wave vector \vec{k}_{ig}, and the out-coupling grating OG is used to provide a first wave vector \vec{k}₁ and a second wave vector \vec{k}₂. The input light emitted by the optical mechanism 200 is coupled into the waveguide substrate 10 for transmission through the wave vector \vec{k}_{ig} provided by the in-coupling grating IG. The light transmitted in the waveguide substrate 10 undergoes a one-dimensional pupil expansion by the wave vector \vec{k}₁ provided by the out-coupling grating OG; the light undergoing the one-dimensional pupil expansion undergoes a two-dimensional pupil expansion and is coupled out through the wave vector \vec{k}₂ provided by the out-coupling grating OG. Alternatively, the light transmitted in the waveguide substrate 10 undergoes a one-dimensional pupil expansion by the wave vector \vec{k}₂ provided by the out-coupling grating OG; the light undergoing the one-dimensional pupil expansion undergoes a two-dimensional pupil expansion and is coupled out through the wave vector \vec{k}₁ provided by the out-coupling grating OG. It should be noted that, when the input light is closed in the wave vector space formed by the interaction with in-coupling grating IG and the out-coupling grating OG, the following conditional expression may be satisfied: \vec{k}_{ig}+\vec{k}₁+\vec{k}₂=0, which may implement out-coupling from the waveguide substrate 10.

It has been found through research that in the actual structure, if the efficiency of the out-coupling grating is low, the light will not be sufficiently out-coupled and be wasted. How to optimize the morphology of the grating by designing, thereby improving the efficiency of the optical waveguide is an important issue in the design of the optical waveguide. According to the implementation of the present disclosure, the rotation angle of the two-dimensional structural element(s) 32 is changed, so that the characteristic axis direction of the two-dimensional structural element(s) 32 forms a relative rotation angle with a direction of a lattice period vector sum of the two-dimensional grating 31 to change a diffraction efficiency of the out-coupling grating 30 in a predetermined direction. The morphology of the grating is optimized, and the efficiency of the optical waveguide is improved. The two-dimensional grating 31 (i.e., the two-dimensional lattice) refers to a grating having a periodic structure in two directions.

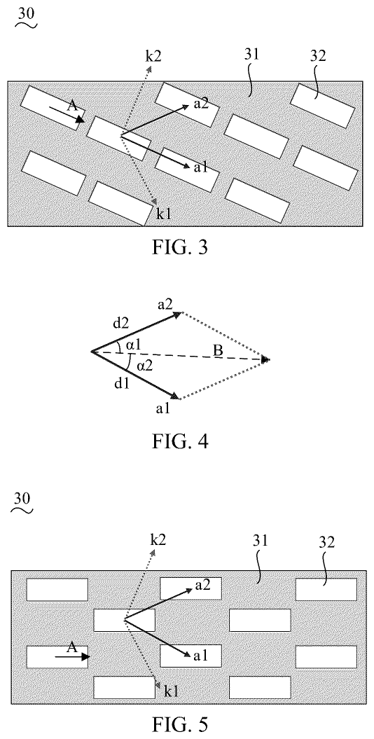

Referring to FIGS. 2 and 3, in some implementations, the two-dimensional grating 31 has a first lattice period direction and a second lattice period direction. A number of the two-dimensional structural element(s) 32 is multiple. The multiple two-dimensional structural elements 32 are arranged in the first lattice period direction and the second lattice period direction. The direction of the lattice period vector sum of the two-dimensional grating 31 is a direction of a sum of a vector of the first lattice period direction and a vector of the second lattice period direction.

Specifically, FIG. 2 and FIG. 3 are schematic diagrams of the plane structure of the out-coupling grating 30 as viewed from bottom to top (or from top to bottom) in FIG. 14. The two-dimensional structural element(s) 32 is a minimal repeating unit (a two-dimensional structural element also be referred to as a cell) in the two-dimensional grating 31. The number of the two-dimensional structural element(s) 32 may be multiple, and the multiple two-dimensional structural element(s)s 32 are distributed in an array as a whole, for example, in a rectangular array distribution or an annular array distribution. A projection shape of the two-dimensional structural element(s) 32 on the two-dimensional grating 31 is a two-dimensional pattern, for example, a rectangle, an ellipse, a parallelogram, or any other shape, and the implementation of the present application is drawn by using a rectangle as an example.

As shown in FIGS. 2 and 3, the first lattice period direction is represented by a1, and the second lattice period direction is represented by a2. The multiple two-dimensional structural elements 32 are arranged in the first lattice period direction a1 and the second lattice period direction a2. That is, the two-dimensional structural elements 32 repeat periodically in the first lattice period direction a1 and repeat periodically in the second lattice period direction a2. An angle is formed between the first lattice period direction a1 and the second lattice period direction a2, and a value of the angle may be between 0 degrees and 180 degrees.

The characteristic axis direction of the two-dimensional structural element(s) 32 represents the principal component direction of the two-dimensional structural element(s) 32, as shown in the directions A in FIG. 2, FIG. 3 and FIG. 5. When the projection shape of the two-dimensional structural element(s) 32 on the two-dimensional grating 31 is rectangular, the characteristic axis direction of the two-dimensional structural element(s) 32 is the direction of the long side of the rectangle, or the length extension direction of the two-dimensional structural element(s) 32. The direction of the lattice period vector sum of the two-dimensional grating 31 refers to the direction of the sum of the vector \vec{a}₁ of the first lattice period direction and the vector \vec{a}₂ of the second lattice period direction, as shown in the direction B in FIG. 4. The vector \vec{a}₁ of the first lattice period direction has a first lattice period direction \vec{a}₁, which has a first lattice period length (i.e., a distance between two adjacent two-dimensional structural elements 32 arranged in the first lattice period direction a1). The vector \vec{a}₂ of the second lattice period direction has a second lattice period direction a2, which has a second lattice period length (i.e., a distance between two adjacent two-dimensional structural elements 32 arranged in the second lattice period direction a2). The lattice period vector sum of the two-dimensional grating 31 is the direction of (\vec{a}₁+\vec{a}₂). The relative rotation angle formed between the characteristic axis direction of the two-dimensional structural element(s) 32 and the lattice period vector sum of the two-dimensional grating 31 is the angle between the direction A and the direction B.

Still referring to FIG. 2 and FIG. 3, in some implementations, the two-dimensional structural element(s) 32 has a first reciprocal lattice vector direction corresponding to the second lattice period direction and a second reciprocal lattice vector direction corresponding to the first lattice period direction. The characteristic axis direction of the two-dimensional structural element(s) 32 forms the relative rotation angle with the direction of the lattice period vector sum of the two-dimensional grating 31 to change a diffraction efficiency of the out-coupling grating 30 in the first reciprocal lattice vector direction or the second reciprocal lattice vector direction.

As shown in FIG. 2 and FIG. 3, the first reciprocal lattice vector direction is represented by k1, and the second reciprocal lattice vector direction is represented by k2. In a specific example of the present application, the out-coupling grating 30 is configured to provide a first wave vector \vec{k}₁ and a second wave vector \vec{k}₂. The direction of the first wave vector \vec{k}₁ is the first reciprocal lattice vector direction k1, and the direction of the second wave vector \vec{k}₂ is the second reciprocal lattice vector direction k2. The first lattice period direction a1 and the second lattice period direction a2 of the two-dimensional grating 31 determine the first reciprocal lattice vector direction k1 and the second reciprocal lattice vector direction k2 of the two-dimensional structural element(s) 32. The first reciprocal lattice vector direction k1 is perpendicular to the second lattice period direction a2, and the second reciprocal lattice vector direction k2 is perpendicular to the first lattice period direction a1. In the implementation of the present disclosure, the characteristic axis direction of the two-dimensional structural element(s) 32 forms the relative rotation angle with the direction of the lattice period vector sum of the two-dimensional grating 31 to change a diffraction efficiency of the out-coupling grating 30 in the first reciprocal lattice vector direction k1 or the second reciprocal lattice vector direction k2.

Referring to FIG. 4, in some implementations, a magnitude of the relative rotation angle is determined based on a first lattice period length, a second lattice period length, and an angle between the first lattice period direction and the second lattice period direction.

Specifically, the first lattice period length may be represented by a distance d1 between two adjacent two-dimensional structural elements 32 arranged in the first lattice period direction a1, and the second lattice period length may be represented by a distance d2 between two adjacent two-dimensional structural elements 32 arranged in the second lattice period direction a2. That is, the magnitude of the relative rotation angle is determined by d1, d2, and the angle between α1 and α2. According to d1, d2 and the angle between a1 and a2, the optimal relative rotation angle α1 or α2 may be obtained by combining the parallelogram rule. When the diffraction efficiency of the out-coupling grating 30 in the first reciprocal lattice vector direction k1 needs to be changed, for example, when the diffraction efficiency of the out-coupling grating 30 in the first reciprocal lattice vector direction k1 is strongest, the relative rotation angle may be set to be α1; when the diffraction efficiency of the out-coupling grating 30 in the second reciprocal lattice vector direction k2 needs to be changed, for example, when the diffraction efficiency of the out-coupling grating 30 in the second reciprocal lattice vector direction k2 is strongest, the relative rotation angle may be set to α2. In an example, when d1=d2, the relative rotation angle is half the angle between α1 and α2. For example, when the angle between α1 and α2 is 60 degrees, the relative rotation angles α1 or α2 are both 30 degrees; for another example, when the angle between α1 and α2 is 90 degrees, the relative rotation angles α1 or α2 are both 45 degrees.

Of course, in other implementations, the magnitude of the relative rotation angle may also not be determined based on the above manner, but should consider a direction in which the diffraction efficiency needs to be increased, and the degree to which the diffraction efficiency needs to be increased, etc., and the above manner is merely an example.

It has also been found through research that, in the actual structure, if the efficiency of the out-coupling grating is high, more energy will be prematurely coupled out after interacting with the out-coupling grating at the front end (a left region of the out-coupling grating as shown in FIG. 1), and at the same time, this part of the prematurely out-coupled light cannot enter the EyeBox region (EyeBox) due to an angle, thereby causing waste of energy. In particular, for blue light, since the propagation angle of the blue light in the waveguide is small, the step size is small, so that the blue light is easier to be coupled out prematurely. Therefore, in the implementation of the present disclosure, the characteristic axis direction of the two-dimensional structural element(s) 32 forms a negative relative rotation angle (as shown in FIG. 2) with the direction of the lattice period vector sum of the two-dimensional grating 31, thereby increasing the diffraction efficiency of the out-coupling grating 30 in the first reciprocal lattice vector direction; or, the characteristic axis direction of the two-dimensional structural element(s) 32 form a positive relative rotation angle (as shown in FIG. 3) with the direction of the lattice period vector sum of the two-dimensional grating 31, thereby increasing the diffraction efficiency of the out-coupling grating 30 in the second reciprocal lattice vector direction, so that the light are more propagated to the direction away from the in-coupling grating 20 (the right region of the out-coupling grating 30 as shown in FIG. 1), thereby improving the display uniformity (the specific principle will be described in the following description).

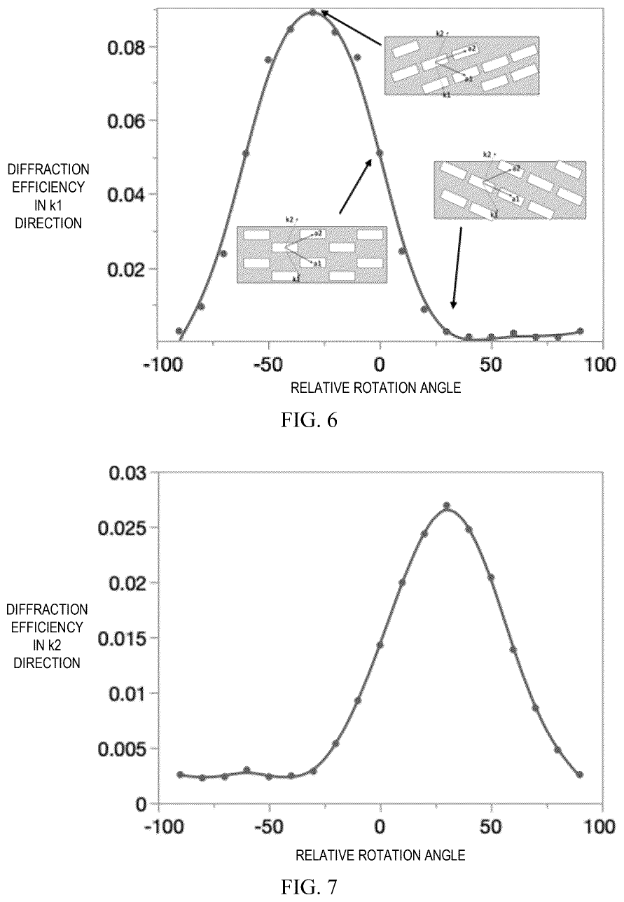

Referring to FIG. 2, FIG. 5, and FIG. 6, in some implementations, the two-dimensional structural element(s) 32 rotates in the first rotation direction, to enable the characteristic axis direction of the two-dimensional structural element(s) 32 to form a negative relative rotation angle with the direction of the lattice period vector sum of the two-dimensional grating 1, thereby increasing a diffraction efficiency of the out-coupling grating 30 in the first reciprocal lattice vector direction. The first rotation direction is a rotation direction from the first lattice period direction to the second lattice period direction.

Specifically, referring to FIG. 5, when the rotation angle of the two-dimensional structural element(s) 32 is not changed, there is no relative rotation angle between the characteristic axis direction of the two-dimensional structural element(s) 32 and the direction of the lattice period vector sum of the two-dimensional grating 31 (that is, the direction A is consistent with the direction B), and the diffraction efficiency of the out-coupling grating 30 in the first reciprocal lattice vector direction k1 and the second reciprocal lattice vector direction k2 is equal. The two-dimensional structural element(s) 32 rotates in the first rotation direction (a direction from the first lattice period direction a1 to the second lattice period direction a2), that is, rotates in the counterclockwise direction in FIG. 5, so that the characteristic axis direction of the two-dimensional structural element(s) 32 forms a negative relative rotation angle (as shown in FIG. 2) with the direction of the lattice period vector sum of the two-dimensional grating 31, thereby increasing the diffraction efficiency of the out-coupling grating 30 in the first reciprocal lattice vector direction k1. The negative relative rotation angle may be represented by α1 in FIG. 4. In an example, when the angle between a1 and a2 is 60 degrees, the two-dimensional structural element(s) 32 rotates counterclockwise by 30 degrees (i.e., α1=−30 degrees), so that the characteristic axis direction of the two-dimensional structural element(s) 32 forms a negative relative rotation angle of minus with the direction of the lattice period vector sum of the two-dimensional grating 31, so that the diffraction efficiency of the out-coupling grating 30 in the first reciprocal lattice vector direction k1 is strong (as shown in FIG. 6).

It should be noted that, during the counterclockwise rotation of the two-dimensional structural element(s) 32, the first lattice period direction a1 and the second lattice period direction a2 are kept unchanged, and the first lattice period direction a1 and the second lattice period direction a2 determine the first reciprocal lattice vector direction k1 and the second reciprocal lattice vector direction k2, and therefore, the first reciprocal lattice vector direction k1 and the second reciprocal lattice vector direction k2 are kept unchanged. In this way, the closing of the wave vector space formed by the input light after interacting with the in-coupling grating 20 and the out-coupling grating 30 will not be affected. The rotation of the two-dimensional structural element(s) 32 is only a rotation of the two-dimensional structural element(s) 32 itself, for example, the rectangular rotation in FIG. 2, so as to change the characteristic axis direction of the two-dimensional structural element(s) 32, thereby increasing the diffraction efficiency of the out-coupling grating 30 in the first reciprocal lattice vector direction k1.

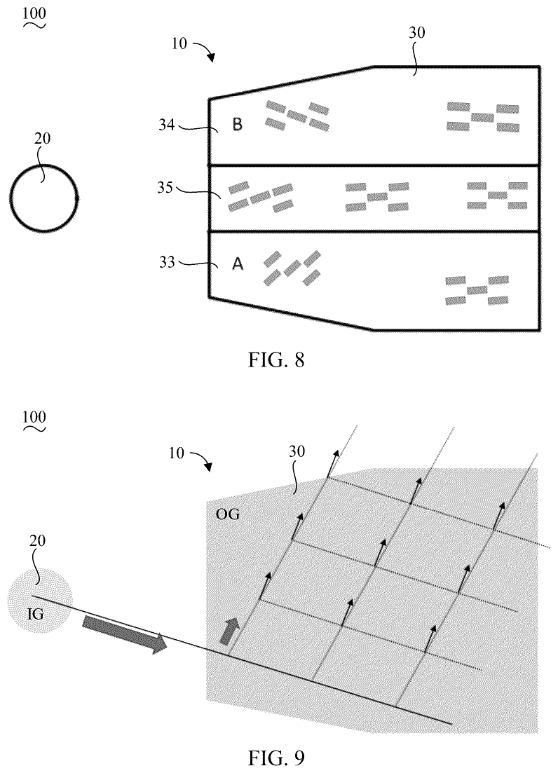

Referring to FIG. 2, FIG. 8 and FIG. 9, in some implementations, the out-coupling grating 30 includes a first grating region 33 corresponding to the first reciprocal lattice vector direction. In the first grating region 33, the characteristic axis direction of the two-dimensional structural element(s) 32 forms a negative relative angle with the direction of the lattice period vector sum of the two-dimensional grating 31.

Specifically, when the light transmitted in the waveguide substrate 10 reaches the out-coupling grating 30, a part of the light obtains the wave vector \vec{k}₁ provided by the out-coupling grating 30 to propagate downwards, and at this time, if the wave vector \vec{k}₂ provided by the out-coupling grating 30 continues to be obtained, the wave vector space is closed, and the part of the light is coupled out from the waveguide substrate 10, and there is a problem of premature out-coupling. In this implementation of the present application, for the first grating region 33 (for example, the region A in FIG. 8) that relatively requires the wave vector \vec{k}₁ to make the light propagate upwards, by causing the characteristic axis direction of the two-dimensional structural element(s) 32 to form a negative relative rotation angle with the direction of the lattice period vector sum of the two-dimensional grating 31, thereby increasing the diffraction efficiency of the out-coupling grating 30 in the first reciprocal lattice vector direction k1, the efficiency that the part of the light continues to obtain the wave vector \vec{k}₁ provided by the out-coupling grating 30 is higher. Since the direction of the wave vector \vec{k}₁ is bidirectional, the wave vector \vec{k}₁ is symmetrical to the wave vector −\vec{k}₁, the efficiency that the part of light continues to obtain the wave vector −\vec{k}₁ provided by the out-coupling grating 30 is higher, and at this time, the obtained \vec{k}₁ cancels out with the obtained −\vec{k}₁, so that the light cannot be immediately coupled out, but continues to propagate forward. In this way, the light can propagate more in a direction away from the in-coupling grating 20, thereby improving display uniformity.

It should be noted that the thick arrow in FIG. 9 is the transmission of the light in the waveguide substrate 10, and the thin arrow is that the light is coupled out from the waveguide substrate 10 (the out-coupling direction is, for example, an outward direction perpendicular to the paper).

Referring to FIG. 3, FIG. 5 and FIG. 7, in some implementations, the two-dimensional structural element(s) 32 rotates in the second rotation direction, to enable the characteristic axis direction of the two-dimensional structural element(s) 32 form a positive relative rotation angle with the direction of the lattice period vector sum of the two-dimensional grating 31, thereby increasing the diffraction efficiency of the out-coupling grating 30 in the second reciprocal lattice vector direction. The second rotation direction is a rotation direction from the second lattice period direction to the first lattice period direction.

Specifically, referring to FIG. 5, when the rotation angle of the two-dimensional structural element(s) 32 is not changed, there is no relative rotation angle between the characteristic axis direction of the two-dimensional structural element(s) 32 and the direction of the lattice period vector sum of the two-dimensional grating 31 (that is, the direction A is consistent with the direction B), and the diffraction efficiency of the out-coupling grating 30 in the first reciprocal lattice vector direction k1 and the second reciprocal lattice vector direction k2 is equal. The two-dimensional structural element(s) 32 rotates in the second rotation direction (the direction from the second lattice period direction a2 to the first lattice period direction a1), that is, the two-dimensional structural element(s) 32 rotates in the clockwise direction in FIG. 5, so that the characteristic axis direction of the two-dimensional structural element(s) 32 form a positive relative rotation angle (as shown in FIG. 3) with the direction of the lattice period vector sum of the two-dimensional grating 31, thereby increasing the diffraction efficiency of the out-coupling grating 30 in the second reciprocal lattice vector direction k2. The positive relative rotation angle may be represented by a2 in FIG. 4. In an example, when the angle between a1 and a2 is 60 degrees, the two-dimensional structural element(s) 32 rotates clockwise by 30 degrees (i.e., α2=30 degrees), so that the characteristic axis direction of the two-dimensional structural element(s) 32 form a positive relative rotation angle of 30 degrees with the direction of the lattice period vector sum of the two-dimensional grating 31, so that the diffraction efficiency of the out-coupling grating 30 in the second reciprocal lattice vector direction k2 is strong (as shown in FIG. 7).

It should be noted that, during clockwise rotation of the two-dimensional structural element(s) 32, the first lattice period direction a1 and the second lattice period direction a2 are kept unchanged, and the first lattice period direction a1 and the second lattice period direction a2 determine the first reciprocal lattice vector direction k1 and the second reciprocal lattice vector direction k2, and therefore, the first reciprocal lattice vector direction k1 and the second reciprocal lattice vector direction k2 are kept unchanged. In this way, the closing of the wave vector space formed by the input light after interacting with the in-coupling grating 20 and the out-coupling grating 30 will not be affected. The rotation of the two-dimensional structural element(s) 32 is only a rotation of the two-dimensional structural element(s) 32 itself, for example, the rectangular rotation in FIG. 3, so as to change the characteristic axis direction of the two-dimensional structural element(s) 32, thereby increasing the diffraction efficiency of the out-coupling grating 30 in the second reciprocal lattice vector direction k2.

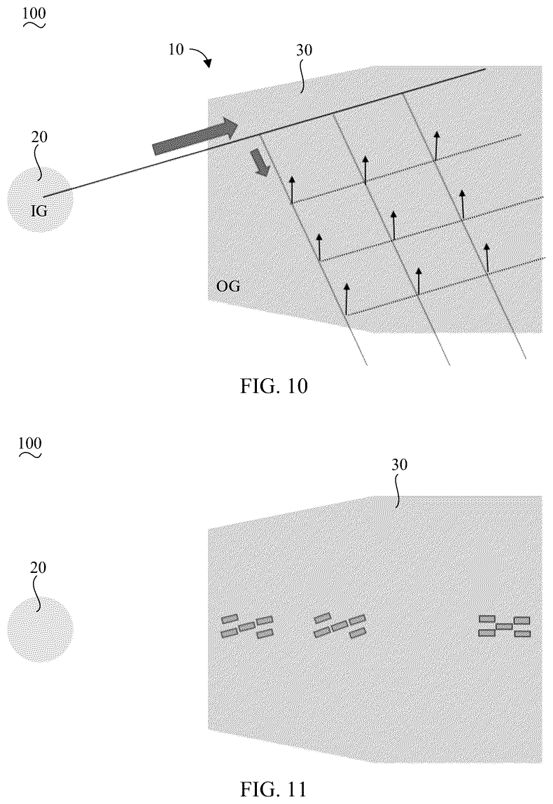

Referring to FIG. 3, FIG. 8 and FIG. 10, in some implementations, the out-coupling grating 30 includes a second grating region 34 corresponding to the second reciprocal lattice vector direction. In the second grating region 34, the characteristic axis direction of the two-dimensional structural element(s) 32 forms a positive relative angle with the direction of the lattice period vector sum of the two-dimensional grating 31.

Specifically, when the light transmitted in the waveguide substrate 10 reaches the out-coupling grating 30, part of the light obtains the wave vector \vec{k}₂ provided by the out-coupling grating 30 to propagate upwards, and at this time, if the wave vector \vec{k}₁ provided by the out-coupling grating 30 continues to be obtained, the wave vector space is closed, and the part of the light is coupled out from the waveguide substrate 10, and there is a problem of premature out-coupling. In this implementation of the present application, for the second grating region 34 (for example, the region B in FIG. 8) that relatively needs the wave vector \vec{k}₂ to make the light to propagate downwards, by making the characteristic axis direction of the two-dimensional structural element(s) 32 form a positive relative rotation angle with the direction of the lattice period vector sum of the two-dimensional grating 31, thereby increasing the diffraction efficiency of the out-coupling grating 30 in the second reciprocal lattice vector direction k2, the efficiency that the part of light continues to obtain the wave vector \vec{k}₂ provided by the out-coupling grating 30 is higher. Since the direction of the wave vector \vec{k}₂ is bidirectional, the wave vector \vec{k}₂ is symmetrical to the wave vector-\vec{k}₂, the efficiency that the part of light continues to obtain the wave vector −\vec{k}₂ provided by the out-coupling grating 30 is higher, and at this time, the obtained \vec{k}₂ cancels out with the obtained −\vec{k}₂, so that the light cannot be immediately coupled out, but continues to propagate forward. In this way, the light can propagate more in a direction away from the in-coupling grating 20, thereby improving display uniformity.

It should be noted that the thick arrow in FIG. 10 is the transmission of the light in the waveguide substrate 10, and the thin arrow is that the light is coupled out from the waveguide substrate 10 (the out-coupling direction is, for example, an outward direction perpendicular to the paper).

Referring to FIG. 8, in some implementations, the out-coupling grating 30 includes a third grating region 35 corresponding to the first reciprocal lattice vector direction and/or the second lattice period direction. In the third grating region 35, the characteristic axis direction of the two-dimensional structural element(s) 32 forms a negative relative rotation angle and/or a positive relative rotation angle with the direction of the lattice period vector sum of the two-dimensional grating 31.

Specifically, in this implementation of the present application, for the third grating region 35 (for example, the middle region of the out-coupling grating 30) that requires the wave vector \vec{k}₁ to enable the light to propagate upwards and the wave vector \vec{k}₂ enables the light to propagate downwards, the characteristic axis direction of the two-dimensional structural element(s) 32 forms a negative relative rotation angle and/or a positive relative rotation angle with the direction of the lattice period vector sum of the two-dimensional grating 31; or, the characteristic axis direction of the partial two-dimensional structural element(s) 32 forms a positive relative rotation angle with the direction of the lattice period vector sum of the two-dimensional grating 31, and the characteristic axis direction of the partial two-dimensional structural element(s) 32 forms a negative relative rotation angle with the direction of the lattice period vector sum of the two-dimensional grating 31. In this way, the light can propagate more in a direction away from the in-coupling grating 20, thereby improving display uniformity. In an example, when the angle between a1 and a2 is 60 degrees, the value of the relative rotation angle formed between the characteristic axis direction of the two-dimensional structural element(s) 32 and the direction of the lattice period vector sum of the two-dimensional grating 31 may be between minus 30 degrees and 30 degrees.

In various implementations of the present disclosure, for different grating regions of the out-coupling grating 30, different relative rotation angles may be formed between the direction of the characteristic axis of the two-dimensional structure element(s) 32 and the direction of the lattice period vector sum of the two-dimensional grating 31 as needed, to optimize the propagation path of the light and the efficiency of the optical waveguide. A value of the relative rotation angle may be between minus 90 degrees and 90 degrees.

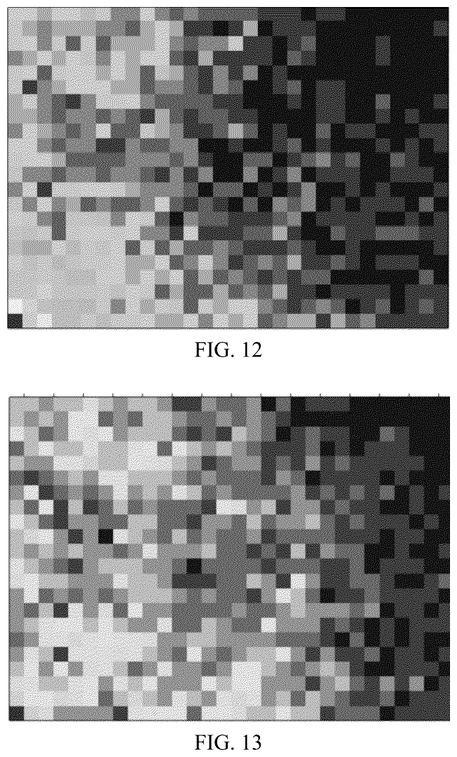

Referring to FIG. 8 and FIG. 11, in some implementations, in a direction away from the in-coupling grating 20, the relative rotation angle changes gradually or stepwise within a spatial range of the out-coupling grating 30.

Specifically, as shown in FIG. 11, in a manner of adjusting the diffraction efficiency of the out-coupling grating 30 in the predetermined direction, the characteristic axis direction of the two-dimensional structural element(s) 32 and the direction of the lattice period vector sum of the two-dimensional grating 31 gradually reach the relative rotation angle. For example, when the relative rotation angle to be set is 60 degrees, the characteristic axis direction of the two-dimensional structural element(s) 32 and the direction of the lattice period vector sum of the two-dimensional grating 31 are sequentially adjusted to the relative rotation angles of 20 degrees, 40 degrees and 60 degrees from no relative rotation angle. In this case, in a direction away from the in-coupling grating 20, the relative rotation angle changes gradually in a spatial range of the out-coupling grating 30, and is specifically gradually reduced.

In another way, as shown in FIG. 8, in the region where the diffraction efficiency of the out-coupling grating 30 in the predetermined direction needs to be adjusted, the characteristic axis direction of the two-dimensional structural element(s) 32 and the direction of the lattice period vector sum of the two-dimensional grating 31 may directly form a relative rotation angle. For example, when the relative rotation angle required to be set is 60 degrees, the characteristic axis direction of the two-dimensional structural element(s) 32 and the direction of the lattice period vector sum of the two-dimensional grating 31 are changed from no relative rotation angle to the relative rotation angle of 60 degrees, and at this time, in the direction away from the in-coupling grating 20, the relative rotation angle is changed in a stepwise manner within the spatial range of the out-coupling grating 30, which is specifically directly smaller.

As shown in Table 1 below, the following is a simulation result of the optical waveguide structure 100 with respect to the optical waveguide efficiency according to an implementation of the present application. It can be seen from Table 1 that for different color lights, the characteristic axis direction of the two-dimensional structural element(s) 32 forms a relative rotation angle with the direction of the lattice period vector sum of the two-dimensional grating 31, and the efficiency of the optical waveguide is obviously improved.

TABLE 1

| Waveguide Efficiency | Red light | Green light | Blue light |
|---|---|---|---|
| With Rotation Angle | 1.3% | 2.2% | 1.4% |
| Without Rotation Angle | 1.4% | 2.5% | 2.0% |

Referring to FIG. 12 and FIG. 13, when there is no relative rotation angle between the characteristic axis direction of the two-dimensional structural element(s) 32 and the direction of the lattice period vector sum of the two-dimensional grating 31, the spatial distribution of the energy of the emitted light in the EyeBox region is shown. FIG. 13 is a schematic diagram of spatial distribution of energy of emitted light in the EyeBox region after a relative rotation angle is formed between the characteristic axis direction of the two-dimensional structural element(s) 32 and the direction of the lattice period vector sum of the two-dimensional grating 31 according to an implementation of the present application. As can be seen from FIG. 12 and FIG. 13, by adjusting the rotation angle of the two-dimensional structural element(s) 32, the intensity of light propagating in different directions can be adjusted, thereby changing the energy emitted from the in-coupling grating 20 and improving the uniformity. In addition, the optical waveguide structure 100 of the implementation of the present disclosure does not increase the processing difficulty.

Referring to FIG. 14, an implementation of the present disclosure further provides an optical waveguide module 300. The optical waveguide module 300 includes the optical waveguide structure 100 and the optical mechanism 200 according to any one of the above implementations. The optical mechanism 200 is configured to emit an input light to the in-coupling grating 20.

In the optical waveguide module 300 of the implementation of the present disclosure, the characteristic axis direction of the two-dimensional structural element(s) 32 and the direction of the lattice period vector of the two-dimensional grating 31 form a relative rotation angle, so as to adjust the diffraction efficiency of the out-coupling grating 30 in the predetermined direction.

Referring to FIG. 15, an implementation of the present application further provides a head-mounted display device 1000. The head-mounted display device 1000 includes the optical waveguide module 300 according to the above implementations. The head-mounted display device 1000 is, for example, an AR display device.

In the head-mounted display device 1000 according to the implementation of the present disclosure, the characteristic axis direction of the two-dimensional structural element(s) 32 forms a relative rotation angle with a direction of a lattice period vector sum of the two-dimensional grating 31 to change a diffraction efficiency of the out-coupling grating 30 in a predetermined direction, so that the morphology of the grating can be optimized, thereby improving the efficiency of the optical waveguide.

In the description of the present application, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and the like are based on the orientation or positional relationship shown in the drawings, and are merely for ease of description of the present application and the simplified description, rather than indicating or implying that the device or element referred to must have a specific orientation, is configured and operated in a specific orientation, and therefore cannot be understood as a limitation on the present application. Furthermore, the terms “first” and “second” are for descriptive purposes only and are not to be construed as indicating or implying relative importance or implicitly indicating the number of indicated technical features. Thus, features defining “first”, “second” may explicitly or implicitly include one or more features. In the description of this application, the meaning of “a plurality of” is two or more unless specifically defined otherwise.

In the description of the present application, it should be noted that, unless specified and defined otherwise, the terms “mounting”, “connecting”, and “associating” should be understood in a broad sense, for example, may be fixedly connected, or may be detachably connected or integrally connected; may be a mechanical connection, or may be an electrical connection; or may be a direct connection, or may be indirectly connected through an intermediate medium, and may be a connection between two elements or an interaction relationship between two elements. For those skilled in the art, the specific meaning of the above terms in the present application may be understood according to specific situations.

In the present application, unless otherwise specified and defined otherwise, the “upper” or “lower” of the first feature on the second feature may include direct contact of the first and second features, or may include that the first and second features are not in direct contact but are in contact by additional features therebetween. Moreover, the first feature “above”, “on” and “top” of the second feature includes the first feature directly above and diagonally above the second feature, or merely representing that the horizontal height of the first feature is higher than that of the second feature. The first feature “below”, “under” and “bottom” of the second feature includes the first feature directly below and diagonally below the second feature, or merely representing that the horizontal height of the first feature is less than that of the second feature.

The above disclosure provides many different implementations or examples for implementing different structures of the present application. In order to simplify the disclosure of the present application, the components and settings of specific examples are described above. Of course, they are merely examples and are not intended to limit the present application. Furthermore, the present application may repeat reference numerals and/or reference letters in different examples, this repetition is for the purpose of simplicity and clarity, which does not itself indicate the relationship between the various implementations and/or settings discussed. Further, the present application provides examples of various specific processes and materials, but one of ordinary skill in the art may appreciate the use of other processes and/or other materials.

In the description of this specification, reference to the description of the terms “one implementation,” “some implementations,” “schematic implementations,” “embodiments,” “examples,” “specific examples,” “some examples,” and the like means that the specific features, structures, materials, or characteristics described in connection with the implementations or examples are included in at least one implementation or example of the present application. In this specification, the schematic expression of the above terms does not necessarily refer to the same implementation or example. Moreover, the specific features, structures, materials, or characteristics described may be combined in any one or more implementations or examples in a suitable manner.

Although implementations of the present application have been shown and described above, those skilled in the art may understand that various changes, modifications, substitutions and variations may be made to these implementations without departing from the principles and principles of the present application, the scope of which is defined by the claims and their equivalents.

I/We claim:

1. An optical waveguide structure, comprising:
a waveguide substrate;
an in-coupling grating configured to couple input light into the waveguide substrate for transmission;
an out-coupling grating configured to perform pupil expansion and out-coupling on light transmitted in the waveguide substrate, wherein the out-coupling grating is a two-dimensional grating, the two-dimensional grating has a two-dimensional structural element(s), and a characteristic axis direction of the two-dimensional structural element(s) forms a relative rotation angle with a direction of a lattice period vector sum of the two-dimensional grating to change a diffraction efficiency of the out-coupling grating in a predetermined direction.

2. The optical waveguide structure of claim 1, wherein the two-dimensional grating has a first lattice period direction and a second lattice period direction, a number of the two-dimensional structural element(s) is multiple, and the multiple two-dimensional structural elements are arranged in the first lattice period direction and the second lattice period direction;
the direction of the lattice period vector sum of the two-dimensional grating is a direction of a sum of a vector of the first lattice period direction and a vector of the second lattice period direction.

3. The optical waveguide structure of claim 2, wherein the two-dimensional structural element(s) has a first reciprocal lattice vector direction corresponding to the second lattice period direction and a second reciprocal lattice vector direction corresponding to the first lattice period direction, and the characteristic axis direction of the two-dimensional structural element(s) forms the relative rotation angle with the direction of the lattice period vector sum of the two-dimensional grating to change a diffraction efficiency of the out-coupling grating in the first reciprocal lattice vector direction or the second reciprocal lattice vector direction.

4. The optical waveguide structure of claim 3, wherein the first reciprocal lattice vector direction is perpendicular to the second lattice period direction, and the second reciprocal lattice vector direction is perpendicular to the first lattice period direction.

5. The optical waveguide structure of claim 3, wherein a magnitude of the relative rotation angle is determined based on a first lattice period length, a second lattice period length, and an angle between the first lattice period direction and the second lattice period direction.

6. The optical waveguide structure of claim 3, wherein the two-dimensional structural element(s) rotates in a first rotation direction, to enable the characteristic axis direction of the two-dimensional structural element(s) to form a negative relative rotation angle with the direction of the lattice period vector sum of the two-dimensional grating, thereby increasing a diffraction efficiency of the out-coupling grating in the first reciprocal lattice vector direction; wherein the first rotation direction is a rotation direction from the first lattice period direction to the second lattice period direction.

7. The optical waveguide structure of claim 6, wherein the out-coupling grating comprises a first grating region corresponding to the first reciprocal lattice vector direction, and in the first grating region, the characteristic axis direction of the two-dimensional structural element(s) forms the negative relative rotation angle with the direction of the lattice period vector sum of the two-dimensional grating.

8. The optical waveguide structure of claim 3, wherein the two-dimensional structural element(s) rotates in a second rotation direction, to enable the characteristic axis direction of the two-dimensional structural element(s) to form a positive relative rotation angle with the direction of the lattice period vector sum of the two-dimensional grating, thereby increasing a diffraction efficiency of the out-coupling grating in the second reciprocal lattice vector direction; wherein the second rotation direction is a rotation direction from the second lattice period direction to the first lattice period direction.

9. The optical waveguide structure of claim 8, wherein the out-coupling grating comprises a second grating region corresponding to the second reciprocal lattice vector direction, and in the second grating region, the characteristic axis direction of the two-dimensional structural element(s) forms the positive relative rotation angle with the direction of the lattice period vector sum of the two-dimensional grating.

10. The optical waveguide structure of claim 3, wherein in a direction away from the in-coupling grating, the relative rotation angle changes gradually or stepwise within a spatial range of the out-coupling grating.

11. An optical waveguide module, comprising:
an optical waveguide structure comprising:
a waveguide substrate;
an in-coupling grating configured to couple input light into the waveguide substrate for transmission; and
an out-coupling grating configured to perform pupil expansion and out-coupling on light transmitted in the waveguide substrate, wherein the out-coupling grating is a two-dimensional grating, the two-dimensional grating has a two-dimensional structural element(s), and a characteristic axis direction of the two-dimensional structural element(s) forms a relative rotation angle with a direction of a lattice period vector sum of the two-dimensional grating to change a diffraction efficiency of the out-coupling grating in a predetermined direction; and
an optical mechanism configured to emit the input light to the in-coupling grating.

12. The optical waveguide module of claim 11, wherein the two-dimensional grating has a first lattice period direction and a second lattice period direction, a number of the two-dimensional structural element(s) is multiple, and the multiple two-dimensional structural elements are arranged in the first lattice period direction and the second lattice period direction;
the direction of the lattice period vector sum of the two-dimensional grating is a direction of a sum of a vector of the first lattice period direction and a vector of the second lattice period direction.

13. The optical waveguide module of claim 12, wherein the two-dimensional structural element(s) has a first reciprocal lattice vector direction corresponding to the second lattice period direction and a second reciprocal lattice vector direction corresponding to the first lattice period direction, and the characteristic axis direction of the two-dimensional structural element(s) forms the relative rotation angle with the direction of the lattice period vector sum of the two-dimensional grating to change a diffraction efficiency of the out-coupling grating in the first reciprocal lattice vector direction or the second reciprocal lattice vector direction.

14. The optical waveguide module of claim 13, wherein the first reciprocal lattice vector direction is perpendicular to the second lattice period direction, and the second reciprocal lattice vector direction is perpendicular to the first lattice period direction.

15. The optical waveguide module of claim 13, wherein a magnitude of the relative rotation angle is determined based on a first lattice period length, a second lattice period length, and an angle between the first lattice period direction and the second lattice period direction.

16. The optical waveguide module of claim 13, wherein the two-dimensional structural element(s) rotates in a first rotation direction, to enable the characteristic axis direction of the two-dimensional structural element(s) to form a negative relative rotation angle with the direction of the lattice period vector sum of the two-dimensional grating, thereby increasing a diffraction efficiency of the out-coupling grating in the first reciprocal lattice vector direction; wherein the first rotation direction is a rotation direction from the first lattice period direction to the second lattice period direction.

17. The optical waveguide module of claim 16, wherein the out-coupling grating comprises a first grating region corresponding to the first reciprocal lattice vector direction, and in the first grating region, the characteristic axis direction of the two-dimensional structural element(s) forms the negative relative rotation angle with the direction of the lattice period vector sum of the two-dimensional grating.

18. The optical waveguide module of claim 13, wherein the two-dimensional structural element(s) rotates in a second rotation direction, to enable the characteristic axis direction of the two-dimensional structural element(s) to form a positive relative rotation angle with the direction of the lattice period vector sum of the two-dimensional grating, thereby increasing a diffraction efficiency of the out-coupling grating in the second reciprocal lattice vector direction; wherein the second rotation direction is a rotation direction from the second lattice period direction to the first lattice period direction.

19. The optical waveguide module of claim 18, wherein the out-coupling grating comprises a second grating region corresponding to the second reciprocal lattice vector direction, and in the second grating region, the characteristic axis direction of the two-dimensional structural element(s) forms the positive relative rotation angle with the direction of the lattice period vector sum of the two-dimensional grating.

20. A head-mounted display device, comprising an optical waveguide module, wherein the optical waveguide module comprises:
an optical waveguide structure comprising:
a waveguide substrate;
an in-coupling grating configured to couple input light into the waveguide substrate for transmission; and
an out-coupling grating configured to perform pupil expansion and out-coupling on light transmitted in the waveguide substrate, wherein the out-coupling grating is a two-dimensional grating, the two-dimensional grating has a two-dimensional structural element(s), and a characteristic axis direction of the two-dimensional structural element(s) forms a relative rotation angle with a direction of a lattice period vector sum of the two-dimensional grating to change a diffraction efficiency of the out-coupling grating in a predetermined direction; and
an optical mechanism configured to emit the input light to the in-coupling grating.
